(19) United States
(12) Patent Application Publication
(10) Pub. No.: US 2005/0124276 A1
(43) Pub. Date: Jun. 9, 2005

(54) Apparatus for flattening and tenderizing meat

(75) Inventor: Eugene D. Gagliardi JR., Atglen, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Packerland Packing Company, Inc.

(21) Appl. No.: 10/987,048

(22) Filed: Nov. 12, 2004

Related U.S. Application Data
(60) Provisional application No. 60/519,594, filed on Nov. 13, 2003.

(51) Int. Cl. A22C 9/00

(52) U.S. Cl. 452/142

(57) ABSTRACT

An apparatus for flattening and tenderizing meat comprises a pair of generally cylindrical macerating rollers each having a generally smooth circumferential outer surface with a plurality of generally parallel, generally equally circumferentially spaced apart ridges extending outwardly from the circumferential surface along the axial length of the roller. The rollers are generally parallel to each other and spaced apart and are supported in a frame in an offset manner for rotation in opposite directions such that during rotation of the rollers the ridges of the first roller fall between the ridges of the second roller with a predetermined distance therebetween and the ridges of the second roller fall within the ridges of the first roller with the predetermined distance therebetween. When meat is fed into the space between the rotating rollers the meat is gripped by the ridges and is pulled between the rollers where the meat is flattened and tenderized by the rollers.

### CROSS-REFERENCE TO RELATED APPLICATIONS

The present application claims priority from U.S. Provisional Patent Application No. 60/519,594 filed Nov. 13, 2003 and entitled “Apparatus For Flattening And Tenderizing Meat”, the entire disclosure of which is hereby incorporated herein by reference.

### BACKGROUND OF THE INVENTION

The present invention is related to the tenderizing of meat and, in particular, to a apparatus for flattening and tenderizing meat in a single step.

Many cuts of meat are particularly difficult to use for certain applications because of the toughness of the muscle involved. Various prior art devices and equipment are employed for tenderizing such cuts of meat. However, such prior right devices and equipment are often difficult to use, are difficult to clean, and do not always provide meat products having a desirable appearance. The present invention comprises a variation of the known devices and equipment which includes a particular way in which rotating rollers engage the meat for both tenderizing the meat while flattening the meat to be nearly paper thin. A special combing device is employed for automatically removing the flattened, tenderized meat from the apparatus, making cleaning much easier.

### BRIEF SUMMARY OF THE INVENTION

Briefly stated, the present invention comprises an apparatus or flattening and tenderizing meat including two macerating rollers. The first roller is generally cylindrical with a generally smooth circumferential outer surface and with a plurality of generally parallel, generally equally circumferentially spaced apart ridges extending outwardly from the circumferential surface by a predetermined distance along the axial length of the first roller. The second roller is generally cylindrical with a generally smooth circumferential outer surface and with a plurality of generally parallel, generally equally circumferentially spaced apart ridges extending outwardly from the circumferential surface by a predetermined distance along the axial length of the second roller. The first and second rollers are generally parallel to each other and spaced apart. The rollers are supported in a frame in an offset manner for rotation in opposite directions such that during rotation of the rollers the ridges of the first roller fall between the ridges of the second roller with a predetermined distance therebetween and the ridges of the second roller fall between the ridges of the first roller with a predetermined distance therebetween. When meat is fed into the space between the rotating rollers, the meat is gripped by the ridges and is pulled between the rollers where the meat is flattened and tenderized by the rollers.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a first roller and comb arrangement of an apparatus for flattening and tenderizing meat in accordance with the preferred embodiment of the present invention;

FIG. 2 is a top plain view of a portion of the apparatus showing the relative positions of the two macerating rollers;

FIG. 3 is a sectional view of the two rollers taken along line 3-3 of FIG. 2;

FIG. 4 is a sectional view of the two rollers taken along line 4-4 of FIG. 2;

FIG. 5 is a perspective view of a piece of meat prior to passing through the apparatus for flattening and tenderizing meat of the present invention;

FIG. 6 is a perspective view of a flattened, tenderized piece of meat which has passed through the apparatus for flattening and tenderizing meat of the present invention;

FIG. 7 is a perspective view of the apparatus for flattening and tenderizing meat of FIG. 1; and

FIG. 8 is an exploded perspective view of the apparatus for flattening and tenderizing meat of FIG. 7 in a disassembled condition.

### DETAILED DESCRIPTION OF THE INVENTION

The present invention comprises an apparatus for flattening and tenderizing meat. Virtually any kind of meat, fish, fowl, seafood or the like can be flattened and tenderized using the apparatus of the present invention. The apparatus of the present invention permits a tougher cut of meat, such as stew beef, to be flattened and tenderized and turned into a more valuable cut of meat which can be sold at a higher price.

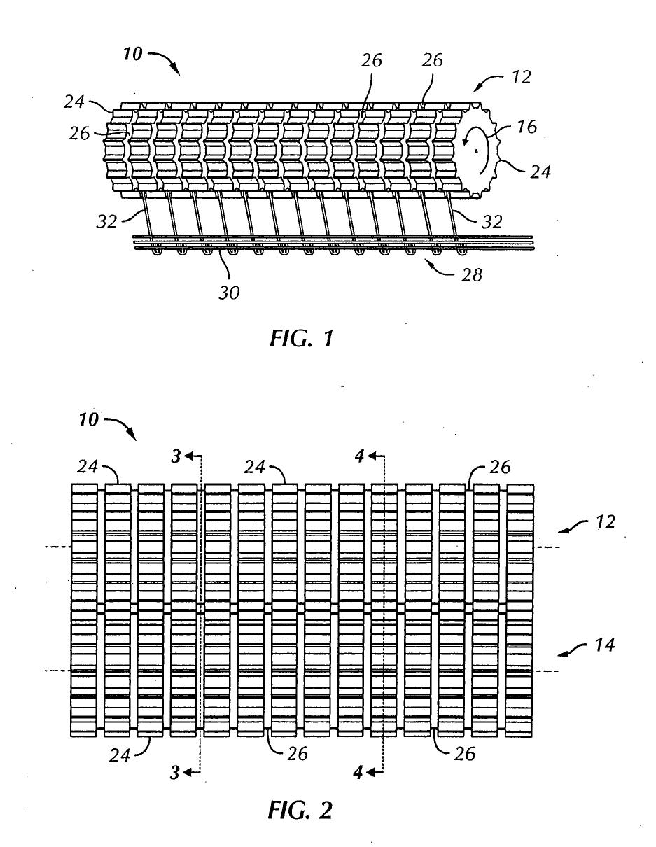

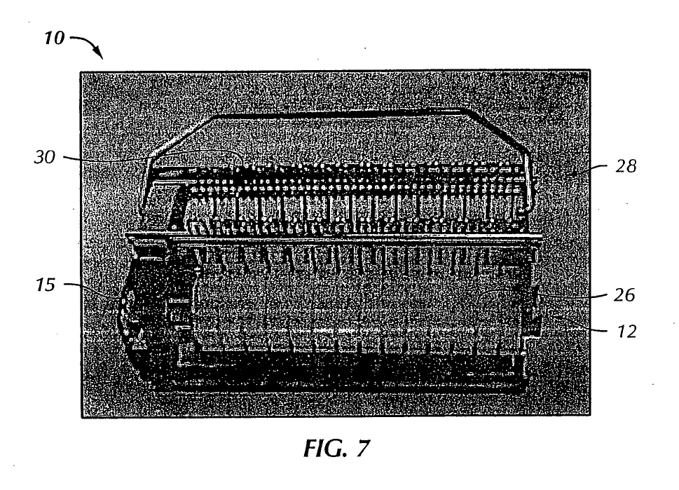

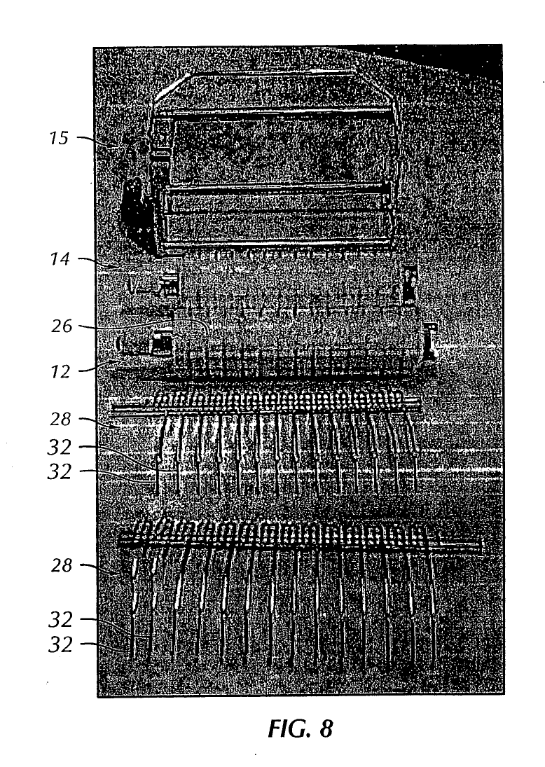

Referring to the Figures, wherein the same new reference numerals are used to indicate the same components throughout the several Figures, there is shown in FIGS. 1-4, 7 and 8 a preferred embodiment of a apparatus 10 which comprises a pair of generally parallel macerating rollers 12, 14 which are retained by a frame 15 and which are driven to rotation in opposite directions as indicated by arrows 16 and 18. Preferably, the present apparatus functions within a known tenderizing machine such as a Biro® Pro-9 Series Machine. However, the present apparatus could be used with other machines or equipment or other techniques could be employed for driving or rotating the rollers 12, 14.

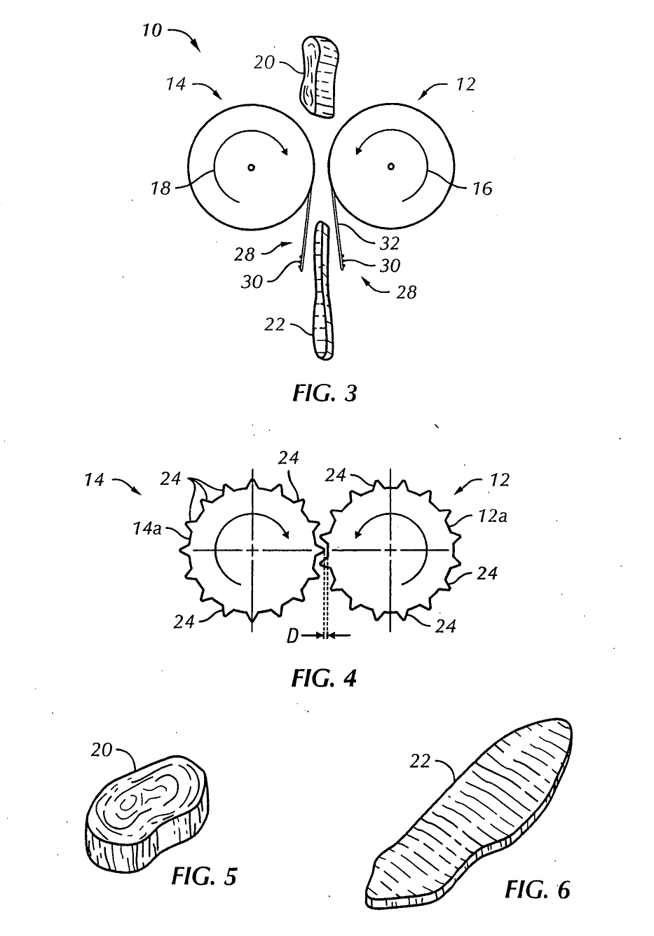

The parallel rollers 12, 14 are spaced apart by a predetermined distance. Preferably the predetermined distance is in the range of about 1/16 of an inch to about ¾ of an inch, a distance which may be adjusted for particular applications. However, other distances would be apparent to those of ordinary skill in the art and would depend upon the size of the meat being tenderized and flattened, the desired final thickness of the meat and other factors apparent to those of skill in the art. As can be appreciated from FIG. 3, the purpose of the rollers 12, 14 is to receive an irregularly shaped piece of meat 20 (FIG. 5) having an initial thickness which is substantially greater than the distance between the rollers 12, 14. Upon passing between the rollers 12, 14, the meat 20 is flattened and tenderized to create a generally flat, irregularly shaped, tenderized piece of meat 22 (FIG. 6) having a thickness which is approximately the same as the predetermined distance between the rollers 12, 14. Preferably, the thickness of the meat 22 is close to “paper thin” making the meat more desirable. An innovative feature of the apparatus 10 is that the rollers 12 and 14 include structural features (hereinafter described) which assist in pulling the meat 20 therebetween for the flattening and tenderizing step. In addition, the present apparatus 10 includes a structure (hereinafter described) which effectively, automatically removes the flattened meat 22 from the rollers 12, 14.

As best show in FIGS. 2, 4 and 8, each of the rollers 12 includes a generally smooth outer circumferential surface having a plurality of generally parallel, generally equally spaced apart ridges 24 which extend outwardly by a predetermined distance along the entire axial length of the circumferential surface of each roller 12, 14. The ridges 24 in the present embodiment are preferably triangular shape in cross-section (see FIG. 4) and the rollers 12, 14 are positioned within the frame 15 so that the ridges 24 of roller 12 are offset from the ridges 24 of roller 14 and so that as the rollers 12 and 14 rotate in opposite directions 16, 18, the ridges 24 of one roller fall within the area between the ridges 24 of the other roller. Preferably, the space between the outermost portion of the ridges 24 of one roller and the opposing circumferential area between the ridges 24 of the other roller is small, preferably in the range of about 1/16 of an inch to ¾ of an inch so that the meat 20 which passes through the area between the rollers 12, 14 comes out very thin. As the meat 20 is fed into the apparatus 10, the meat 20 is generally continuously engaged and gripped by one or more of the ridges on one side or the other side or both sides to pull the meat 20 into the area between the rollers 12, 14. The offset ridges 24 (FIG. 4) permit the rollers 12, 14 to be positioned very close together so that the meat passing between the rollers 12, 14 is simultaneously flattened, scored and perforated for tenderizing and emerges with a thickness which is close to the predetermined distance between the rollers 12, 14 and is almost paper thin. The thickness or depth of the ridges 24, the spacing between the ridges 24 and the number of ridges 24 on each roller 12, 14 may vary for particular applications. In addition, in some applications, the ridges 24 may have a cross-sectional shape which is not triangular. For example, in some applications the ridges 24 will have a generally flat outer surface (like a truncated triangle) as opposed to coming to a point in cross-section. Other variations of the size, shape and spacing of the ridges 24 will be apparent to those of ordinary skill in the art. Preferably the circumferential portions of the rollers 12 and 14 between the ridges are generally smooth and continuous and are large enough to receive the ridges 24 of the opposing roller without actual engagement.

As best shown in FIGS. 1, 2 and 8, each of the rollers 12, 14 further includes a plurality of generally circumferentially extending grooves 26. Each of the grooves extends completely circumferentially around the outer surface of each of the rollers and through the ridges 24. The grooves 26 are axially spaced apart at predetermined distances along the entire length of each of the rollers 12, 14. As shown in FIG. 2, the grooves 26 in roller 12 are generally aligned with the grooves 26 of roller 14 when the rollers 12 and 14 are installed within the frame 15. Preferably, each of the grooves 26 is generally rectangular in cross-section and extends into the outer circumferential surface of the corresponding roller 12, 14 by a predetermined distance which is preferably in the range of ¼ inch to ½ inch. It will be appreciated by those of ordinary skill in the art that the size of the grooves 26, the spacing between the grooves 26, the shape of the grooves 26 and the dimensions of the grooves 26 may vary in a particular application.

Each of the rollers 12, 14 when installed within the frame 15 is engaged by a comb assembly 28. As best shown in FIGS. 1, 3, 7 and 8, each comb assembly 28 includes a base member 30 which is secured to the frame 15 at a predetermined location beneath the respective rollers 12, 14. Each comb assembly 28 also includes a plurality of outwardly extending tines 32. The number of tines 32 and the spacing of the tines 32 is selected so that each tine 32 corresponds to and is aligned with one of the roller grooves 26 as shown in FIG. 1. As best shown in FIGS. 1, 3 and 8, the distal end of each of the tines 32 is generally curved to correspond to the curvature of the roller grooves 26. The ends of the tines 32 proximate to the base 30 are generally straight. Preferably, the tines 32 have a width and a thickness which is at slightly less than the depth and width of the roller grooves 26 so that the tines 32 may reside within the roller grooves 26 without undue friction created as the rollers 12, 14 rotate. The comb assembly 28, and particularly the tines 32, functions to effectively remove any of the flattened, tenderized meat which has passed through the area between the rollers 12, 14 and which may tend to stick to the ridges 24 of the rollers 12, 14 after flattening. Preferably, each comb assembly 28, and particularly the tines 32, is formed of a high strength material such as steel, stainless steel or some other metal alloy or the like. Preferably the rollers 12, 14 including the ridges 24 are also formed of a generally rigid high strength material such as steel, stainless steel or the like.

Meat products formed using the above-described apparatus 10 could be use for sauteing, grilling, stir frying, scallopini, breaded products, in casseroles, or the like. Alternatively, the flattened, paper thin, tenderized meat pieces could be mixed in a mixer to produce a meat mass which could then be formed into a restructured meat product. The apparatus 10 could be used with virtually any muscle cuts of virtually any animal, including beef, pork, chicken, lamb, veal, turkey or any other type of fowl or seafood. Alternatively, the present apparatus could be used for flattening and tenderizing vegetables, dough or virtually any other type of food product.

It will be appreciated by those skilled in the art that changes could be made to the embodiment described above without departing from the broad inventive concepts thereof. For example, the shape of the ridges 24 could be varied, the number of ridges could be varied, the size of the ridges could be varied and the distance between the outer surfaces of the ridges and the opposing circumferential roller surfaces could be varied. It is understood, therefore, that this invention is not limited to the particular embodiment disclosed, but is intended to cover all modifications within the spirit and scope of the present invention as defined by the appended claims.

1. An apparatus for flattening and tenderizing meat comprising:
a first generally cylindrical macerating roller having a generally smooth circumferential outer surface with a plurality of generally parallel, equally circumferentially spaced apart ridges extending outwardly from the circumferential surface by a predetermined distance along the axial length of the first roller;
a second generally cylindrical macerating roller having a generally smooth circumferential outer surface with a plurality of generally parallel, generally equally circumferentially spaced apart ridges extending outwardly from the circumferential surface by a predetermined distance along the axially length of the second roller; and
the first and second rollers being generally parallel to each other and spaced apart, the rollers being supported in a frame in an offset manner for rotation in opposite directions such that during rotation of the rollers, the ridges of the first roller fall between the ridges of the second roller with a predetermined distance therebetween and the ridges of the second roller fall between the ridges of the first roller with the predetermined distance therebetween, whereby meat which is fed into the space between the rotating rollers is gripped by the ridges and pulled between the rollers where the meat is flattened and tenderized by the rollers.

2. The apparatus for flattening and tenderizing meat as recited in claim 1, wherein the ridges are generally triangular shaped in cross-section.

3. The apparatus for flattening and tenderizing meat as recited in claim 1 wherein the predetermined distance is in the range of 1/16 of a inch to ¾ of an inch.

4. The apparatus for flattening and tenderizing meat as recited in claim 1, wherein each roller further includes a plurality of generally circumferentially extending, axially spaced apart grooves and wherein the apparatus further comprises a pair of comb assemblies, each comb assembly including a base member secured to the frame and a plurality of tines extending outwardly from the base member, the number and spacing of the tines of each comb assembly corresponding to the number and spacing of the grooves of each roller, the tines of each comb assembly residing in the grooves of one of the rollers to remove the flattened, tenderized meat from the rollers.

5. The apparatus recited in claim 1, wherein the rollers are formed of a generally rigid high-strength material.

6. The apparatus for flattening and tenderizing meat as recited in claim 5, wherein the material comprises one of steel, stainless steel or another metal alloy.

7. The apparatus for flattening and tenderizing meat as recited in claim 4, wherein the grooves are generally rectangular in cross-section.
